(19) United States
(12) Patent Application Publication
(10) Pub. No.: US 2003/0078895 A1
(43) Pub. Date: Apr. 24, 2003

(54) Use of cellular phones for payment of vending machines

(76) Inventor: George MacKay, Glasgow (CA)

Correspondence Address: Norman P. Soloway, HAYES SOLOWAY P.C., 130 W. Cushing Street, Tucson, AZ, 85701, US

(21) Appl. No.: 10/273,029

(22) Filed: Oct. 17, 2002

Related U.S. Application Data
(60) Provisional application No. 60/330,069, filed on Oct. 19, 2001.

(51) Int. Cl. G06F 17/60

(52) U.S. Cl. 705/64

(57) ABSTRACT

A cellular phone payment system for making payment for goods or service, which comprises three parts: 1) a user's cellular phone, which could also be any other form of mobile communications device provided that it can be linked to the public phone system, 2) an on-street vending machine, and 3) a remote payment auto-attendant computer with modem, which can be accessed by the public phone system. The user's cellular phone is the communications link or conduit used to access the remote payment auto-attendant computer, as well as to relay instructions to the user once user verification has been completed. The user calls the auto-attendant, authenticates his/her identity, and then is given instructions on how to make remote cellular payment on the vending machine in question. The user follows the instructions, which consists of indicating what good/service is being purchased, and then entering a sequence of challenges and responses between the remote auto-attendant computer and the vending machine to validate and confirm payment on the machine. The user uses the phone keypad and the keypad on the vending machine as the data entry means. Once the payment cycle is successfully completed, the payment will have been securely authenticated, the good/service provided, and the users preferred payment method, has been debited the corresponding amount. The payment will have been accomplished with the vending machine offline.

This application claims the benefit of U.S. Provisional Patent Application Serial No. 60/330,069 filed on Oct. 19, 2001.

### FIELD OF THE INVENTION

The invention relates generally to the use of vending machines and more particularly to a system and method for making payment at vending machines using cellular phones.

### BACKGROUND OF THE INVENTION

When obtaining a product, such as confections, or a service, such as parking time, from a vending machine, payment is usually made using currency. Debit cards or credit cards might also be used for payment, however this payment method is usually employed when the vending machine is on-line, which in turn adds to the overhead costs of operating the vending equipment. If the equipment is not on-line, the equipment owner may still consider using credit card for payment, however he takes on the risk of accepting fraudulent credit cards. Other vending machine systems may use identity cards for payment, which are scanned by the system or which transmit a signal to the system, in order to receive the desired product or service. However, in these cases, the system must either be on-line or be able to recognize the user.

Therefore, there is a need for a more universal system and alternative method for making payment for the products or services at vending machines.

### SUMMARY OF THE INVENTION

The invention is directed to a cellular phone payment system and method for making payment for goods or services from a vending machine. The system includes the vending machine, which provides the good/service after accepting an authorization from a user, and an auto-attendant that provides the authorization to the user. The user obtains the authorization from the auto-attendant by communicating with the auto-attendant over a cellular phone network, whereby the user requests to make payment for the purchase of the vending machine good/service.

In accordance with another aspect of the invention, the auto-attendant comprises a computer processor for processing the user requests and a communications module for communicating with a user's cellular phone. The auto-attendant may further comprise a database for storing account records.

The method of making payments for vending machine purchases comprises providing an auto-attendant that communicates with a user through a cellular phone network; requesting the auto-attendant by the user to make payment for the purchase of a vending machine good/service; authorizing the purchase by the auto-attendant; accepting the authorization by the vending machine and providing the good/service.

In accordance with another aspect of the invention a cellular phone, which may include any type of mobile communications device, may be used to communicate between the user and the auto-attendant.

Regarding a further aspect of the invention account data is stored in a database associated with the auto-attendant.

In a system of making payments for vending machine purchases having an auto-attendant that communicates with a user cellular phone through a cellular phone network and provides the user authorization for the purchase, and a vending machine for accepting the authorization from the user to provide the good/service, the method of making payments comprises: calling the auto-attendant using the cellular phone; sending vending machine identification to the auto-attendant; receiving a “challenge” number from the auto-attendant; entering information regarding the requested good/service and the “challenge” number into the vending machine; receiving a “payby-phone” response number from the vending machine; entering the “pay-by-phone” response number in the auto-attendant; receiving a “confirmation” number from the auto-attendant and entering the “confirmation” number into the vending machine.

In accordance with a further aspect of the invention, a user's ID may be sent to the auto-attendant as well as method of payment information.

In a system of making payments for vending machine purchases having an auto-attendant that communicates with a user cellular phone through a cellular phone network and provides authorization to the user for the purchase, the method of confirming payment by the auto-attendant comprises: receiving a cellular phone call from a user; requesting the user for the vending machine identification; receiving the vending machine identification; providing the user a “challenge” number; receiving a “pay-by-phone” response number from the user; obtaining authorization for the user to make payment using a selected account and providing a “confirmation” number to the user to be used to obtain the good/service.

In accordance with another aspect of the invention, the method may further include requesting the user's ID and receiving the user's ID as well as requesting the user for the type and number of the user's desired payment method and receiving the type and number of the user's payment method.

In a system of making payments for vending machine purchases having an auto-attendant that communicates with a user cellular phone through a cellular phone network and provides the user authorization for the purchase, and a vending machine for providing the good/service, the method of providing the good/service by the vending machine comprises: providing the user the option to pay by phone; receiving information regarding the good/service requested; providing a “pay-by-phone response” number to the user; receiving a “confirmation” number from the user; and providing the good/service to the user.

In accordance with a particular aspect of the invention, the good/service may be a parking service.

### BRIEF DESCRIPTION OF THE DRAWINGS

The invention will be described with reference to the accompanying drawings, wherein:

FIG. 1 is schematic of the pay-by-phone system in accordance with the present invention;

FIGS. 2a and 2b are flow charts of the pay-by-phone method in accordance with the present invention;

FIG. 3 illustrates a parking pay and display machine; and

FIGS. 4a to 4d illustrate various screens on the parking pay and display machine used in the pay by phone system.

### DETAILED DESCRIPTION OF THE INVENTION

Many vending machines such as off-line Pay & Display parking machines are stand-alone devices that have computer processors with which a user may interact. These machines do not have any type of direct line or telephone connection, they are therefore normally designed to accept payment by currency or from locally stored accounts of regular users for the specific vending machine. Users that have city wide accounts, for instance, or who might want to pay by some form of debit or credit card would not be able to obtain goods, such as confections, or services, such as parking time, from these vending machines.

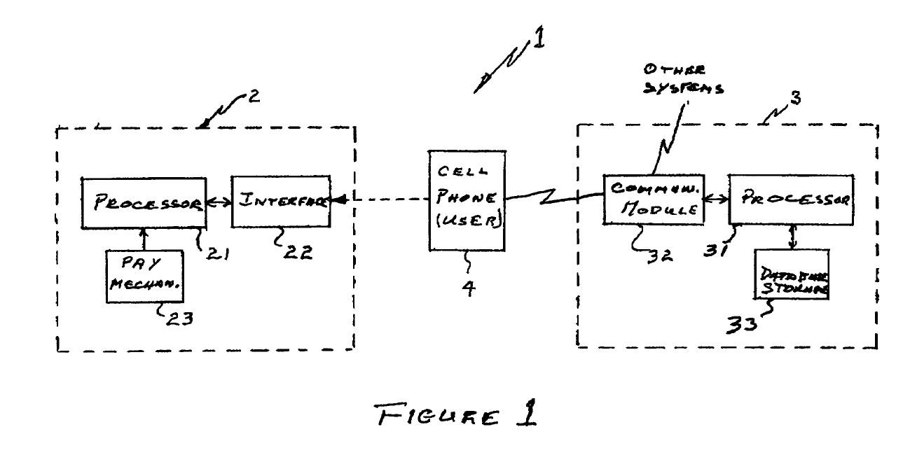

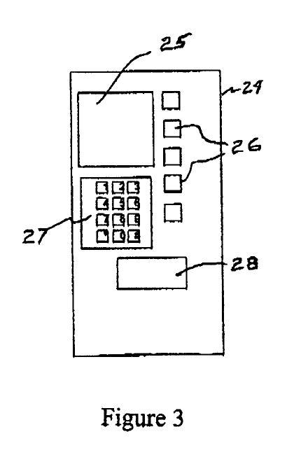

The system in accordance with the present invention is schematically illustrated in FIG. 1. The system 1 comprises a stand alone vending machine 2, which has a computer processor 21 for operating the machine 2, a user interface 22, such as a monitor screen and control buttons for a user to interact with the machine through the processor 21, as well as a mechanism 23 for accepting payment from a user requesting a good or a service. The payment mechanism 23 for a stand-alone machine would accept cash payments and/or cards dedicated to the particular standalone machine 2. However, in accordance with the present invention, the processor 21 is further programmed for the payments of purchases using a cellular phone payment as will described below. Thus, the user's cellular phone 4 becomes an integral part of the payment system 1. FIG. 3 illustrates an example of the face of a Pay & Display parking machine 24 having a screen 25, control buttons 26, a numerical keypad 27 and a slot 28 for accepting payment in the usual manner.

The system 1 further includes an auto-attendant 3 for processing the payment of goods or services. The auto-attendant 3 includes a computer processor 31 as well as a communications module 32 that is capable of two-way communication through a telephone network and/or cellular phone network. The auto-attendant processor 31 is programmed to receive requests for the electronic payment of goods and services from cellular phone 4 users, to verify the user's method of payment and to provide the cellular phone user with an authorizing code, which is described below as “confirmation” number, to obtain the goods or services from the vending machine 2.

The auto-attendant system 1 can serve both account and non-account users. Data regarding account users is stored in a user database 33 in the auto-attendant 3. Alternately, the auto-attendant 3 seeks authorization from credit card, debit card or telephone billing services to charge the payment for the good or service, if this is the payment method selected by the user. For example, non-account users may have the good/service, i.e. the cost of the parking vended time for instance, added to their regular phone bill, or debited to an authorized debit or credit card; while account callers may have the service deducted from the balance of their account with the parking authority.

The auto-attendant 3 may be part of a multifunction accounting system that verifies and applies charges for purchases from any of various types of vending machines as well as for other forms of purchases.

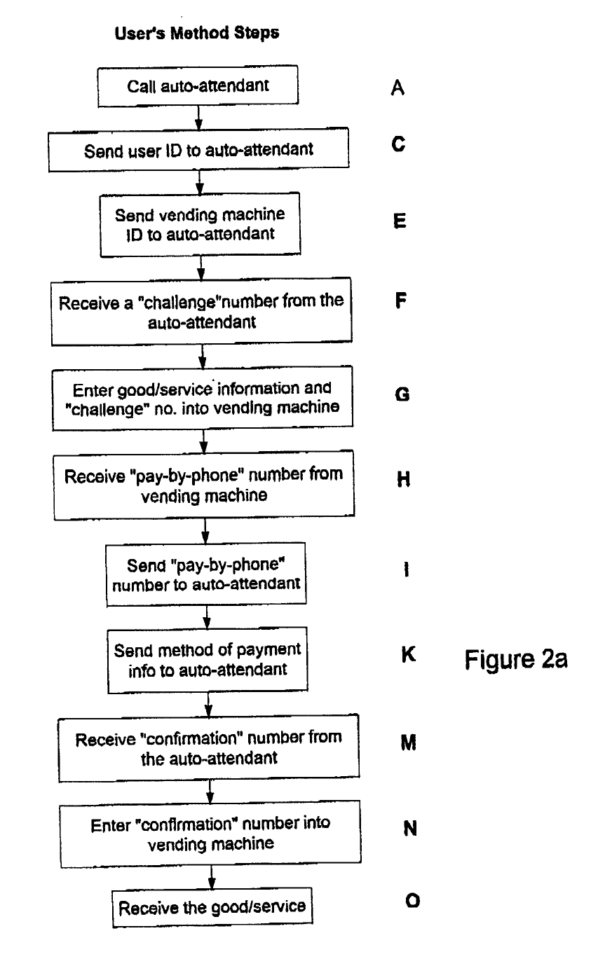

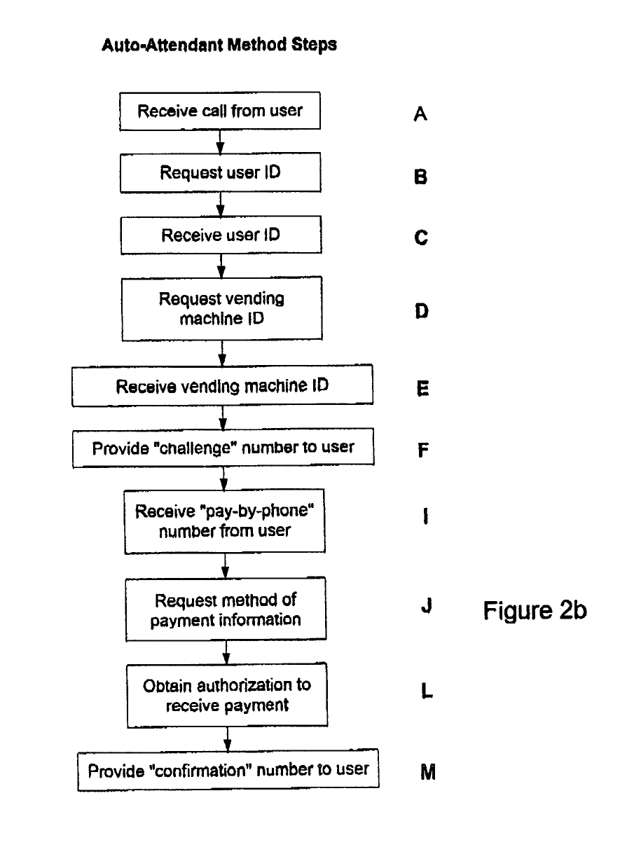

The process for making payments at vending machines using cellular phones is illustrated in the flow diagrams where FIG. 2a illustrates the steps that the user takes while FIG. 2b illustrates the steps that occur within the auto-attendant. The process includes the following steps:

A- the user calls the auto-attendant 3 by cellular phone 4;

B- the auto-attendant 3 responds by requesting a user's ID, which may be the cellular phone number;

C- the user provides the user's ID to the auto-attendant 3;

D- the auto-attendant 3 responds by requesting the vending machine's 2 location or to identify the vending machine in question, each vending machine may be identified by its own unique vending machine number;

E- the user provides the vending machine's 2 number or location to the auto-attendant 3 through the cellular phone's keypad;

F- the auto-attendant 3 provides the user with a “challenge” number to be entered into the vending machine 2 keypad;

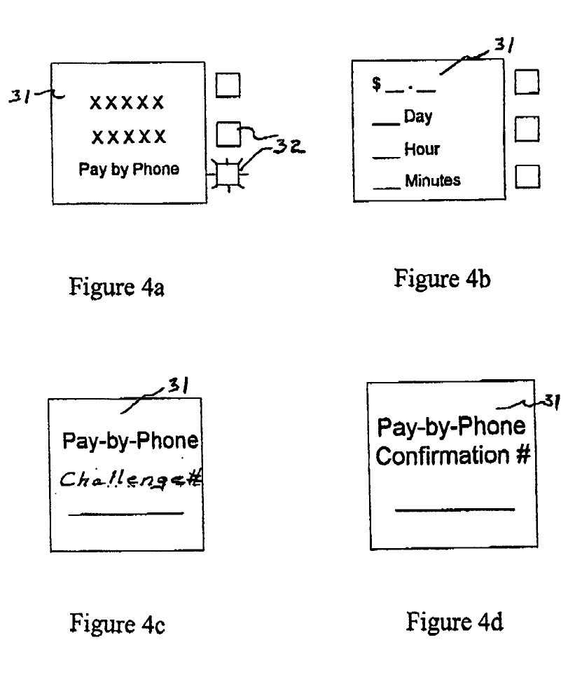

G- the user selects “pay-by-phone” as the payment type on the vending machine 2, followed by the good/service requested, the amount of payment to be made and the challenge number; FIGS. 4a to 4c illustrate a series of screens which may appear on a Pay & Display parking machine 24 to carryout this step. The screen in FIG. 4a is the initial screen for the Pay & Display parking machine. It prompts the user to select the desired method of payment for the parking. The selections may include pay by cash, pay by account and pay by phone, for instance. The user selects the method of payment by pressing one of the buttons 32. This will bring up the screen in FIG. 4b, which prompts the user to enter the amount of payment and the parking desired. This information can be entered using the numerical keypad 33. A third screen will then appear requesting the user to enter the “challenge” number which again can be done using the numerical keypad 33.

H- the vending machine 2 provides a “pay-by-phone response” number to the user;

I- the user provides the “pay-by-phone response” number to the auto-attendant 3;

J- the auto-attendant responds by asking the type and number of the payment method;

K- the user provides the payment method information to the auto-attendant 3;

L- the auto-attendant 3 obtains authorization to receive payment from the user's phone account, debit card account or charge card account as indicated by the user;

M- the auto-attendant 3 issues a “confirmation” number to the user;

N- the user enters the “confirmation” number into the vending machine. After the user entered the “challenge” number in step above, the Pay & Display parking machine brings up the screen illustrated on FIG. 4d, which prompts the user to enter the “confirmation” number;

O- the vending machine 2 provides the user with the good/service, which in the case of a Pay & Display parking machine will be a ticket to be placed in the user's vehicle.

From the time the initial call is made to the auto-attendant 3—step A—until the time the auto-attendant 3 issues the confirmation number to the user—step M—, the cellular phone link between the cellular phone 4 and the auto-attendant 3 is maintained. In addition, steps A to F, I to K and M are all carried out using the cellular phone, while steps G, H, N and O are all carried out by the user directly on the vending machine 2. Step L by the auto-attendant 3 is carried out by interrogating the database 33 or by using the communications module 32 to contact a telephone account, a debit card account or a credit card account to obtain authorization to debit these for payment of the good/service. The interactions between the user and the auto-attendant 3 may all take place by visual communications on a cellular phone screen or by audio communication. In addition, all of the functions of the auto-attendant may be automated without the need of human intervention.

Though a specific method has been described above, some of the steps may be performed in a different manner or excluded. For example, steps B and C may be excluded by using the cellular phone 4 number as the user's ID and having the auto-attendant 3 automatically identify the cellular phone 4 number. The information provided to the auto-attendant 3 in step G following the “pay-by-phone” selection may follow any desired sequence. In addition, steps J and K may be excluded by storing a specific payment method in the database 33 associated with a particular ID number.

Using the system and the method described above, a purchase is authenticated with no direct intervention between the auto-attendant 3 and the vending machine 2; the user with the cellular phone 4 acts as an intermediary. The user's cellular phone 4 is the communications link or conduit used to access the remote payment auto-attendant 3, as well as to relay instructions to the user once user verification has been completed. The user calls the auto-attendant 3, authenticates his/her identity, and then is given instructions on how to make remote cellular payment on the vending machine 2 in question. The user follows the instructions, which consists of indicating good/service that is being purchased, and then entering a sequence of challenges and responses between the remote auto-attendant 3 and the vending machine 2 to validate and confirm payment on the machine 2. The user uses the phone 4 keypad and the keypad on the vending machine 2 as the data entry means. Once the payment cycle is successfully completed, the payment will have been securely authenticated, the good/service provided and the users preferred payment method, i.e. cellular phone, credit card, or line of credit, has been debited the corresponding amount. The payment will have been accomplished with the vending machine off-line, and without the equipment owner taking on any additional risk to fraud.

Though the invention was described in terms of using a cellular phone as the communications link, the terms are meant to include all types of mobile communications devices that can be linked to the public telephone system. In addition, though the payment system can be applied to all types of vending machines, the system is readily adaptable to parking machines such as Pay & Display or Pay by Space parking machines.

It is evident that the auto-attendant system 1 is particularly advantageous for use with an off-line vending machine; however, this does not preclude its use with online vending machines since it provides another option for making payments for good/services.

While the invention has been described according to what is presently considered to be the most practical and preferred embodiment, it must be understood that the invention is not limited to the disclosed embodiment. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

What is claimed is:

1. A system of making payments for vending machine purchases comprising:
auto-attendant means adapted to communicate with a user through a cellular phone network, whereby the user requests to make payment for the purchase of a vending machine good/service and the auto-attendant provides an authorization for the purchase; and
means within the vending machine for accepting the authorization from the user and for providing the good/service.

2. A system of making payments for vending machine purchases as claimed in claim 1 wherein the auto-attendant means comprises:
a computer processor for processing the user requests; and
a communications module for communicating with a user's cellular phone.

3. A system of making payments for vending machine purchases as claimed in claim 2 wherein the auto-attendant means further comprises database means for storing account records.

4. A system of making payments for vending machine purchases as claimed in claim 1 wherein the good/service is a parking service.

5. A method of making payments for vending machine purchases comprising:
providing auto-attendant means adapted to communicate with a user through a cellular phone network;
requesting the auto-attendant means by the user to make payment for the purchase of a vending machine good/service;
authorizing the purchase by the auto-attendant; and
providing means within the vending machine for accepting the authorization from the user and for providing the good/service.

6. A method of making payments for vending machine purchases as claimed in claim 5 comprising communicating between the user and the auto-attendant means by cellular phone.

7. A method of making payments for vending machine purchases as claimed in claim 6 comprising storing account data in a database means associated with the auto-attendant.

8. A method of making payments for vending machine purchases as claimed in claim 5 wherein the good/service is a parking service.

9. In a system of making payments for vending machine purchases having an auto-attendant adapted to communicate with a user cellular phone through a cellular phone network for providing the user authorization for the purchase, and a vending machine for accepting the authorization from the user to provide the good/service, the method of making payments comprising:
a. calling the auto-attendant using the cellular phone;
b. sending vending machine identification to the auto-attendant;
c. receiving a “challenge” number from the auto-attendant;
d. entering information regarding the requested good/service and the “challenge” number into the vending machine;
e. receiving a “pay-by-phone” response number from the vending machine;
f. entering the “pay-by-phone” response number in the auto-attendant;
g. receiving a “confirmation” number from the auto-attendant; and
h. entering the “confirmation” number into the vending machine.

10. The method of making payments as claimed in claim 9 which further includes the step of sending a user's ID to the auto-attendant after step a.

11. The method of making payments as claimed in claim 9 which further includes the step of sending method of payment information to the auto-attendant after step f.

12. The method of making payments as claimed in claim 9 which further includes the step of receiving the good/service from the vending machine after step h.

13. The method of making payments as claimed in claim 9 wherein the good/service information in step d. comprises a good/service specifically desired and the payment amount required.

14. The method of making payments as claimed in claim 9 which further includes the step of obtaining authorization by the auto-attendant to receive the payment after step f.

15. The method of making payments as claimed in claim 9 wherein the good/service is a parking service.

16. In a system of making payments for vending machine purchases having an auto-attendant adapted to communicate with a user cellular phone through a cellular phone network for providing authorization to the user for the purchase, the method of confirming payment by the auto-attendant comprising:
a. receiving a cellular phone call from a user;
b. requesting the user for the vending machine identification;
c. receiving the vending machine identification;
d. providing the user a “challenge” number;
e. receiving a “pay-by-phone” response number from the user;
f. obtaining authorization for the user to make payment using a selected account; and
g. providing a “confirmation” number to the user to be used to obtain the good/service.

17. The method of confirming payment by the auto-attendant as claimed in claim 16 which further comprises requesting the user's ID and receiving the user's ID following step a.

18. The method of confirming payment by the auto-attendant as claimed in claim 16 which further comprises requesting the user for the type and number of the user's desired payment method, and receiving the type and number of the user's payment method from the user following step e.

19. The method of confirming payment by the auto-attendant as claimed in claim 16 wherein the good/service is a parking service.

20. In a system of making payments for vending machine purchases having an auto-attendant adapted to communicate with a user cellular phone through a cellular phone network for providing authorization to the user for the purchase, the auto-attendant comprising:
means for receiving a cellular phone call from a user;
means for requesting the user for the vending machine identification;
means for receiving the vending machine identification;
means for providing the user a “challenge” number;
means for receiving a “pay-by-phone” response number from the user;
means for obtaining authorization for the user to make payment using a selected account; and
means for providing a “confirmation” number to the user to be used to obtain the good/service.

21. The auto-attendant as claimed in claim 20 which further comprises:
means for requesting the user's ID; and
means for receiving the user's ID.

22. The auto-attendant as claimed in claim 20 which further comprises:
means for requesting the user for the type and number of the user's desired payment method; and
means for receiving the type and number of the user's payment method from the user.

23. The auto-attendant as claimed in claim 20 wherein the good/service is a parking service.

24. In a system of making payments for vending machine purchases having an auto-attendant adapted to communicate with a user cellular phone through a cellular phone network for providing the user authorization for the purchase, and a vending machine for providing the good/service, the method of providing the good/service by the vending machine comprising:
a. providing the user the option to pay by phone;
b. receiving information regarding the good/service requested;
c. providing a “pay-by-phone response” number to the user;
d. receiving a “confirmation” number from the user; and
e. providing the good/device to the user.

25. The method of providing the good/service as claimed in claim 24 wherein the good/service is a parking service.

26. In a system of making payments for vending machine purchases having an auto-attendant adapted to communicate with a user cellular phone through a cellular phone network for providing the user authorization for the purchase, and a vending machine for providing the good/service, the vending machine comprising:
means for providing the user the option to pay by phone;
means for receiving information regarding the good/service requested;
means for providing a “pay-by-phone response” number to the user;
means for receiving a “confirmation” number from the user; and
means for providing the good/device to the user.

27. The vending machine as claimed in claim 26 wherein the good/service is a parking service.
